(19) United States
(12) Patent Application Publication
(10) Pub. No.: US 2016/0050049 A1
(43) Pub. Date: Feb. 18, 2016

(54) MANAGING HYBRID AUTOMATIC REPEAT REQUEST (HARQ) SOFT BUFFER IN TD-HSDPA FOR DUAL SIM DUAL STANDBY (DSDS) DEVICE

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/457,626

(22) Filed: Aug. 12, 2014

(51) Int. Cl. H04L 1/18; H04L 1/08; H04W 72/14

(52) U.S. Cl. CPC H04L 1/1812; H04W 72/14; H04L 1/08

(57) ABSTRACT

A method of wireless communication includes receiving a first grant and first high speed downlink data before tuning away from a first RAT and storing the first high speed data in a buffer corresponding to a first HARQ ID indicated in the first grant after failing to decode the first high speed downlink data. The method also includes receiving a second grant and second high speed data after tuning back to the first RAT after tuning away to a second RAT. The method further includes determining whether the second high speed data is a new transmission or a retransmission of the first high speed data without processing a new data indicator.

### BACKGROUND

1. Field

Aspects of the present disclosure relate generally to wireless communication systems, and more particularly, to managing a Hybrid Automatic Repeat Request (HARQ) soft buffer in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes receiving a first grant and first high speed downlink data before tuning away from a first RAT. The method also includes storing the first high speed data in a buffer corresponding to a first HARQ ID indicated in the first grant after failing to decode the first high speed downlink data. The method further includes receiving a second grant and second high speed data after tuning back to the first RAT after tuning away to a second RAT. The method still further includes determining whether the second high speed data is a new transmission or a retransmission of the first high speed data without processing a new data indicator.

Another aspect of the present disclosure is directed to an apparatus including means for receiving a first grant and first high speed downlink data before tuning away from a first RAT. The apparatus also includes means for storing the first high speed data in a buffer corresponding to a first HARQ ID indicated in the first grant after failing to decode the first high speed downlink data. The apparatus further includes means for receiving a second grant and second high speed data after tuning back to the first RAT after tuning away to a second RAT. The apparatus still further includes means for determining whether the second high speed data is a new transmission or a retransmission of the first high speed data without processing a new data indicator.

In another aspect of the present disclosure, a computer program product for wireless communications in a wireless network is disclosed. The computer program product includes a non-transitory computer readable medium. The computer readable medium has non-transitory program code recorded thereon which, when executed by the processor(s), causes the processor(s) to perform operations of receiving a first grant and first high speed downlink data before tuning away from a first RAT. The program code also causes the processor(s) to store the first high speed data in a buffer corresponding to a first HARQ ID indicated in the first grant after failing to decode the first high speed downlink data. The program code further causes the processor(s) to receive a second grant and second high speed data after tuning back to the first RAT after tuning away to a second RAT. The program code still further causes the processor(s) to determine whether the second high speed data is a new transmission or a retransmission of the first high speed data without processing a new data indicator.

Another aspect of the present disclosure is directed to an apparatus for wireless communication. The apparatus includes a memory and one or more processors coupled to the memory. The processor(s) is configured to receive a first grant and first high speed downlink data before tuning away from a first RAT. The processor(s) is also configured to store the first high speed data in a buffer corresponding to a first HARQ ID indicated in the first grant after failing to decode the first high speed downlink data. The processor(s) is further configured to receive a second grant and second high speed data after tuning back to the first RAT after tuning away to a second RAT. The processor(s) is still further configured to determine whether the second high speed data is a new transmission or a retransmission of the first high speed data without processing a new data indicator.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a flow diagram for managing a HARQ buffer for a multi-SIM multi-standby device according to an aspect of the present disclosure.

FIG. 6 is a block diagram illustrating a method for managing a HARQ buffer for a multi-SIM multi-standby device according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

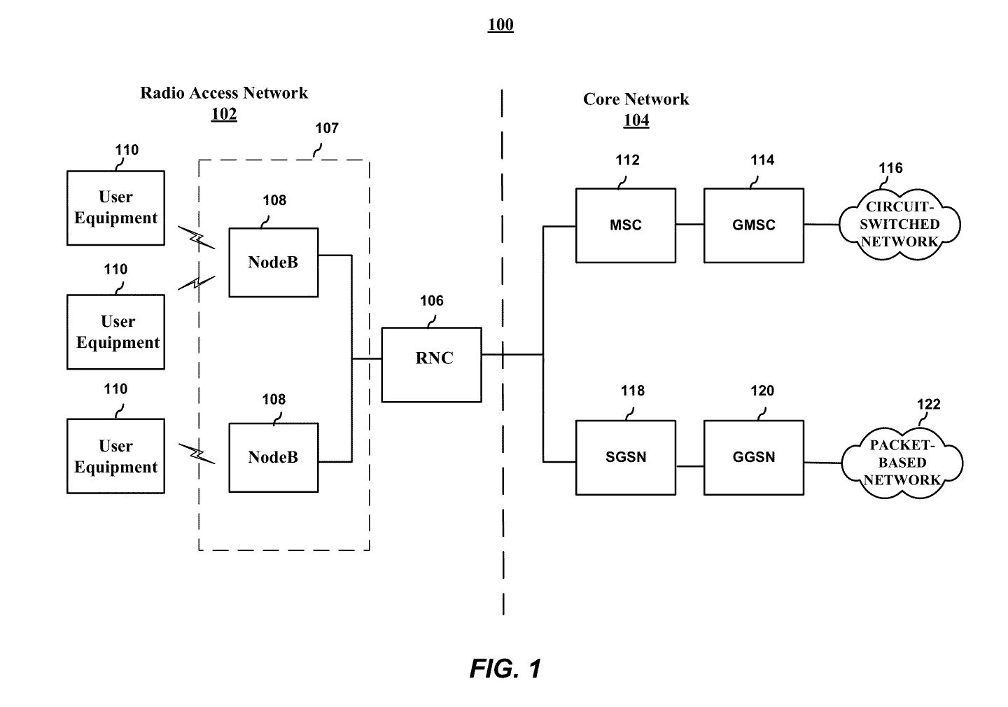

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

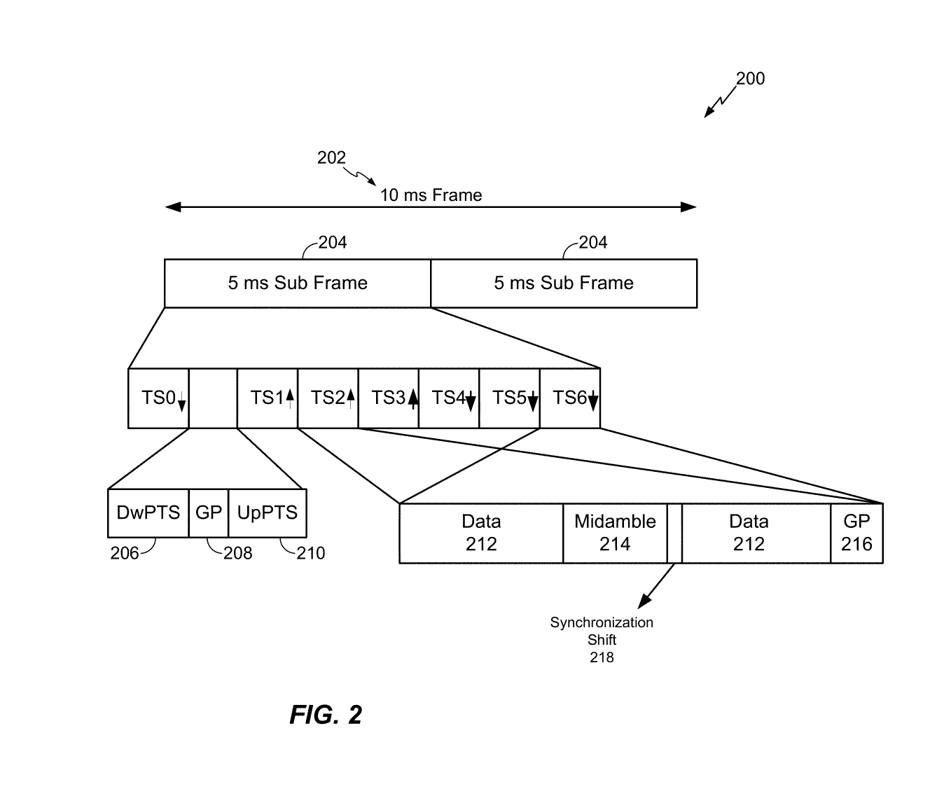

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

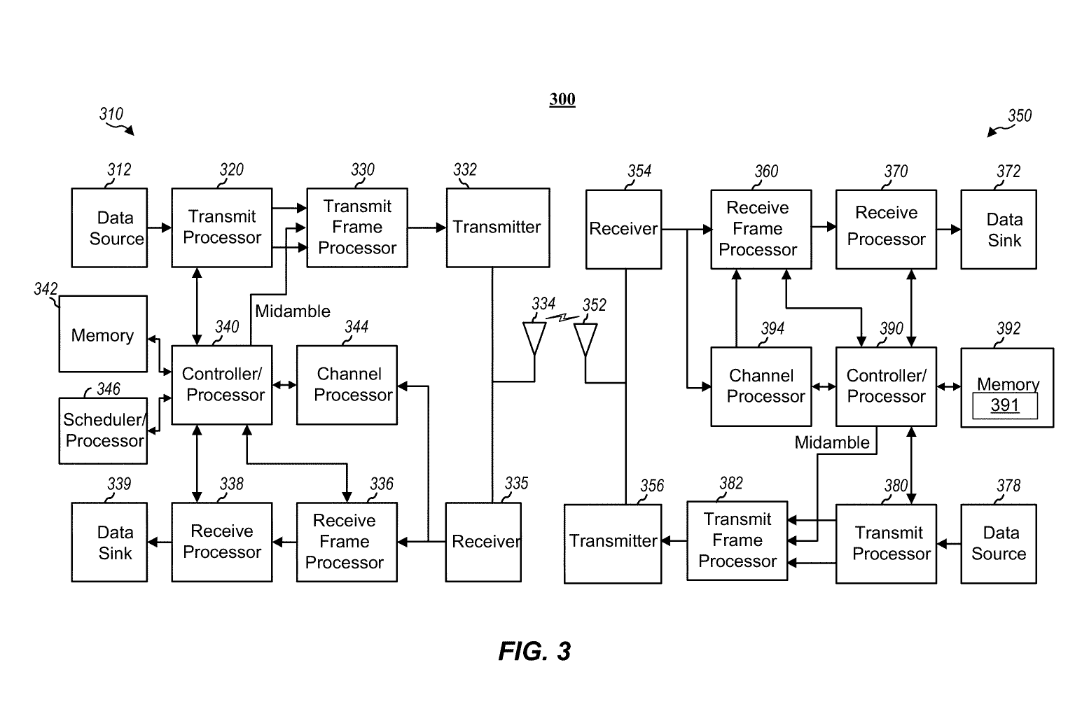

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store the grant determining module 391 which, when executed by the controller/processor 390, configures the UE 350 for attempting to determine whether a grant received after tuning back to a RAT is for a new high speed data transmission or for a high speed data re-transmission. A scheduler/processor 346 at the node B 310 may be used to allocate resources to the UEs and schedule downlink and/or uplink transmissions for the UEs.

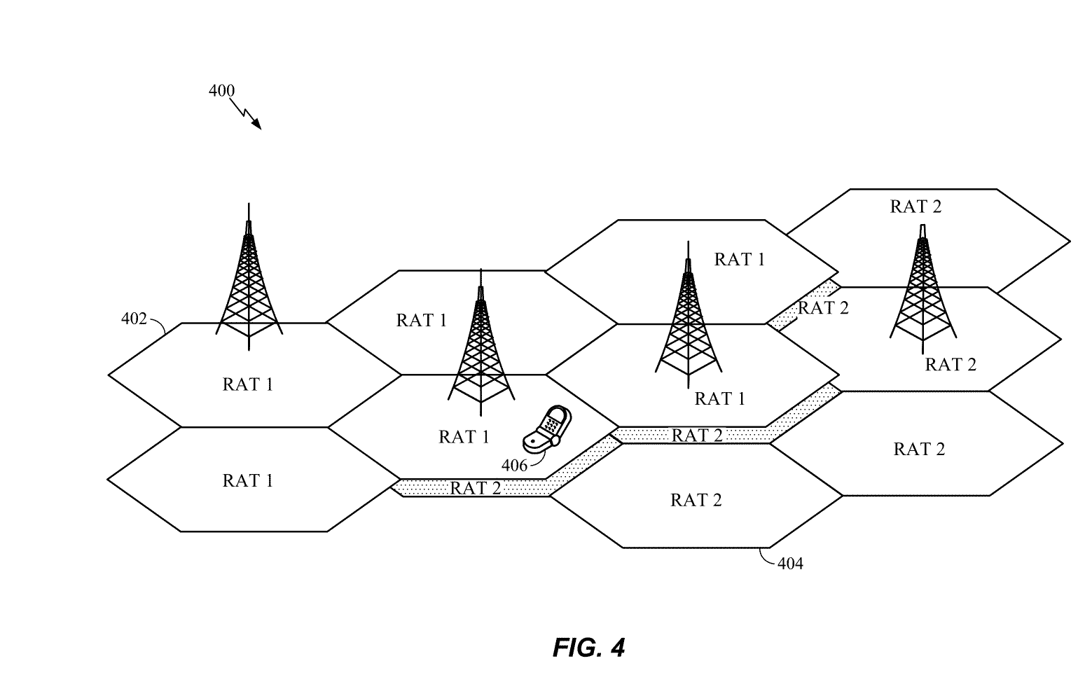

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as a GSM network, and also illustrates a newly deployed network utilizing a second type of radio access technology (RAT-2), such as a TD-SCDMA network.

The geographical area 400 may include RAT-1 cells 402 and RAT-2 cells 404. In one example, the RAT-1 cells are GSM cells and the RAT-2 cells are TD-SCDMA cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

High speed networks are utilized to improve the uplink and downlink throughput. In particular, the high speed downlink packet access (HSDPA) or time division high speed downlink packet access (TD-HSUPA) is a set of enhancements to time division synchronous code division multiple access (TD-SCDMA) in order to improve downlink throughput. Additionally, the high speed uplink packet access (HSUPA) or time division high speed uplink packet access (TD-HSUPA) is a set of enhancements to time division synchronous code division multiple access (TD-SCDMA) in order to improve uplink throughput.

The following describes various TD-HSDPA physical channels. The high-speed physical downlink shared channel (HS-PDSCH) carries a user data burst(s). The high-speed shared control channel (HS-SCCH), also referred to as the grant channel, carries the modulation and coding scheme, channelization code, time slot and transport block size information for the data burst in HS-PDSCH. The HS-SCCH also carries the HARQ process, redundancy version, and new data indicator information for the data burst. Additionally, the HS-SCCH carries the HS-SCCH cyclic sequence number which increments a UE specific cyclic sequence number for each HS-SCCH transmission. Further, the HS-SCCH carries the UE identity to indicate which UE should receive the data burst allocation.

The high-speed shared information channel (HS-SICH) is also referred to as the feedback channel. The HS-SICH carries the channel quality index (CQI), the recommended transport block size (RTBS) and the recommended modulation format (RMF). Additionally, the HS-SICH also carries the HARQ ACK/NACK of the HS-PDSCH transmissions.

The following describes various TD-HSUPA physical channels. The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels. The hybrid automatic repeat request (hybrid ARQ or HARQ) indication channel for E-DCH (E-HICH) carries HARQ ACK/NAK signals.

The operation of TD-HSUPA may also have the following steps. First, in the resource request step, the UE sends requests (e.g., via scheduling information (SI)) via the E-PUCH or the E-RUCCH to a base station (e.g., NodeB). The requests are for permission to transmit on the uplink channels. Next, in a resource allocation step, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid retransmission of erroneously received data packets between the UE and the base station.

The transmission of SI (scheduling information) may consist of two types in TD-HSUPA: (1) In-band and (2) Out-band. For in-band, which may be included in MAC-e PDU (medium access control e-type protocol data unit) on the E-PUCH, data can be sent standalone or may piggyback on a data packet. For Out-band, data may be sent on the E-RUCCH in case that the UE does not have a grant. Otherwise, the grant expires.

The scheduling information (SI) may include the following information or fields: the highest priority logical channel ID (HLID) field, the total E-DCH buffer status (TEBS) field, the highest priority logical channel buffer status (HLBS) field and the UE power headroom (UPH) field.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cells and the neighboring cells. The base station scheduler incorporates the SNPL for inter-cell interference management tasks to avoid neighbor cell overload.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique International Mobile Subscriber Identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using a single radio frequency (RF) chain to transmit and receive communications. In one example, a multi-SIM device includes a first SIM dedicated to operate in first RAT and a second SIM dedicated to operate in a second RAT. In one illustrative example, the multi-SIM device includes a first SIM configured to operate in GSM and a second SIM configured to operate in TD-SCDMA. When the TD-SCDMA subscription is in the dedicated channel (DCH) state without voice traffic, the multi-SIM device supports the TD-SCDMA to GSM tune away with the least amount of interruption to the TD-SCDMA DCH operation. When the UE is in the TD-SCDMA dedicated channel, the UE periodically tunes away from TD-SCDMA, and tunes to GSM to monitor for pages. If the GSM subscription detects a page when the TD-SCDMA to GSM tune away is active, the multi-SIM UE suspends all operations of the TD-SCMA subscription and transitions to another RAT. If the other RAT subscription does not detect a page, the UE tunes back to TD-SCDMA and attempts to recover to the original operation of the TD-SCDMA subscription. The multi-SIM device may operate in other RATS known to those skilled in the art.

### Managing a HARQ Buffer for a Multi-SIM Multi-Standby Device

In a conventional system, when a UE tunes back after a tune away, the soft buffer is flushed when the length of the tune away gap is greater than a pre-determined time. In some cases, the NodeB does not transmit a grant for a data re-transmission. Therefore, flushing the buffer may cause HARQ failure because the NodeB transmits redundancy bits for incremental redundancy combining The transmission of the redundancy bits may reduce network throughput.

In some cases, the UE may miss a grant and/or a new data indication (NDI) toggle during a tune away. The UE may tune away to perform an activity such as monitoring for paging information of a second RAT, collecting a system information block (SIB) of a second RAT, and/or performing cell reselection for a second RAT. After tuning back, when the UE receives a grant from the same HARQ process ID as the grant received prior to tuning away, the UE may not be able to determine whether the grant is for a new transmission or a re-transmission for the HARQ process if the UE did not receive the one bit new data indication toggle.

That is, while tuned away, the UE may miss the new data indication toggle indicating that the next transmission is a re-transmission or a new transmission. Therefore, upon tuning back and receiving a grant for the same HARQ process ID, the UE is not aware as to whether the grant and data transmission are for a new transmission or a re-transmission. Aspects of the present disclosure are directed to improving the determining of whether the grant is for a new transmission or a re-transmission without processing the new data indication toggle when a UE tunes back to a first RAT after tuning away to a second RAT.

In one configuration, before tuning way, the UE receives a grant via a control channel, such as the high-speed shared control channel, and data on a downlink shared channel, such as the high-speed shared downlink channel. If the UE fails to decode the data, the UE records the grant information, such as the transport block (TB) size and radio resource allocation and stores the received data in a buffer, such as a HARQ soft buffer, according the HARQ process ID associated with the data. The UE may receive a grant for the same HARQ process ID after tuning back. It should be noted that aspects of the present disclosure are directed to receiving high speed data via a high-speed shared downlink channel and a grant via a high-speed shared control channel. Still, aspects of the present disclosure are also contemplated for receiving data and/or grants via other types of channels.

Furthermore, in the present configuration, to determine whether the grant received after tuning back is for a new data transmission or a data re-transmission without processing a new data indicator, the UE compares the transport block size index and radio resource information included in the grant received before tuning away and the transport block size index and radio resource information included grant received after tuning back.

It should be noted that the UE compares the aforementioned information when both received grants are for the same HARQ process ID. In the present configuration, the UE determines the transport block size based on the transport block index and allocated radio resources indicated in the grant. In one configuration, the allocated radio resources are time slots allocated to the UE. The UE also determines the transport block size based on the UE category. In the present application, the grant and data received prior to the UE tuning away from the first RAT to the second RAT may be referred to as the first data and the first grant. Additionally, the grant and data received after to the UE tunes back to the first RAT may be referred to as the second data and the second grant.

According to an aspect of the present disclosure, if the transport block size has changed, the UE considers the second grant as a grant for a new transmission. When the grant is for the new transmission, the UE flushes the first data stored in the buffer and stores the second data in the same buffer. Furthermore, the UE attempts to decode the second data stored in the buffer.

Alternatively, if the transport block size of the first grant and the second grant are the same, the UE stores the second data associated in a temporary buffer, such as a temporary HARQ buffer, and attempts to decode the second data without a soft combine. In the present configuration, if the decoding is successful, the UE flushes both the temporary buffer and the buffer and transmits an ACK to the NodeB. If decoding is unsuccessful, the UE performs a soft combine with the first data in the buffer and the second data in the temporary buffer and attempts to decode the combined data. If the decoding is successful, the UE flushes the first data in the buffer. If the decoding is not successful, the UE moves bits, such as soft bits, from the temporary buffer to overwrite the buffer.

Aspects of the present disclosure are specified to reduce the HARQ failure after tuning back and reduce high speed data throughput degradation due to tuning away. That is, in a conventional system, the data lost due to a HARQ failure is recovered via upper layer re-transmission, such as RLC and TCP (transmission control protocol). Therefore, the high speed data throughput is reduced.

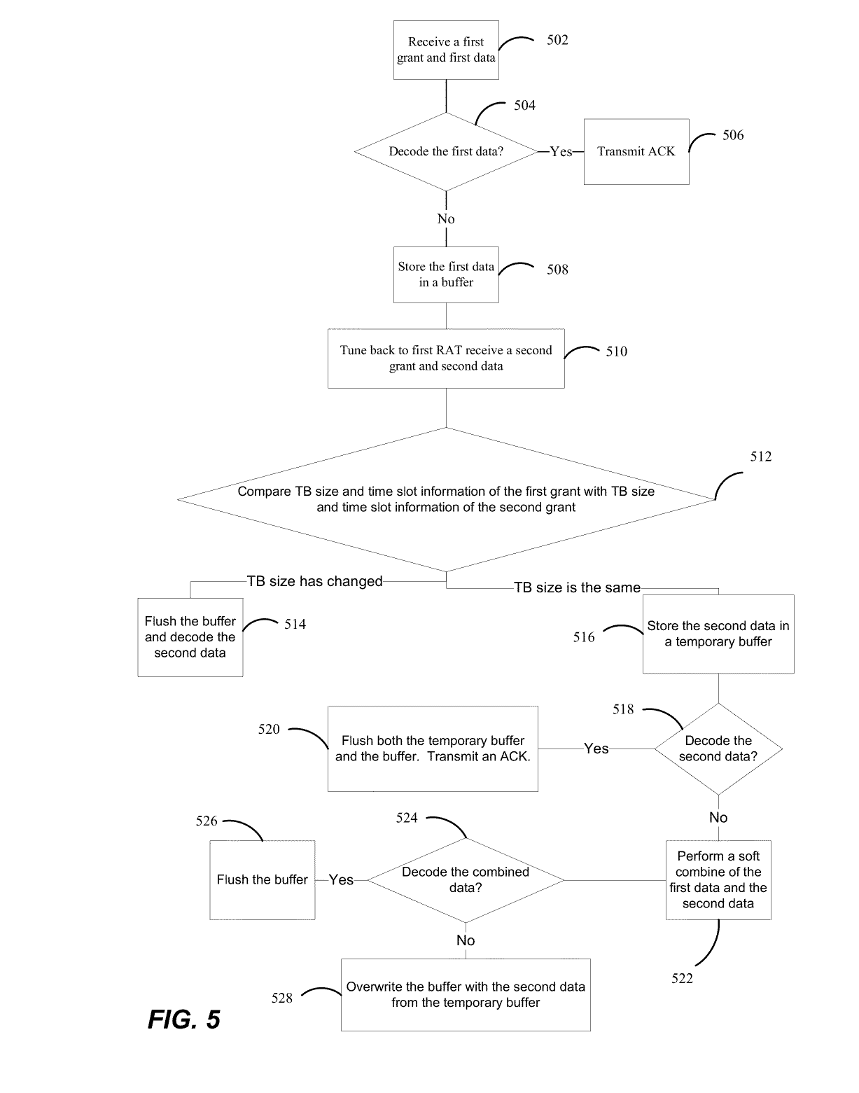

FIG. 5 is a flow diagram 500 for managing buffers, such as HARQ buffers, according to an aspect of the present disclosure. At block 502, a UE is tuned to a first RAT and receives a first grant via a grant channel, such as a high-speed shared control channel. Furthermore, at block 502, the UE also receives first data via a data channel, such as a high-speed shared downlink channel. At block 504, the UE attempts to decode the first data. If the UE decodes the first data, the UE transmits an ACK (acknowledgement) to the NodeB at block 506. After transmitting the ACK, the UE may tune away to a second RAT to perform an activity (not shown). If the UE cannot decode the first data (at 504), then the UE stores the first data in a buffer, at block 508, such as a HARQ soft buffer. The UE stores the first data based on the HARQ process ID associated with the first data. Furthermore, in one configuration, the UE only stores a sample of the first data in the buffer.

At block 510 the UE tunes back to the first RAT after performing an activity on the second RAT and receives a second grant via the grant channel. In one configuration, if the second grant is for the same HARQ process ID as the first grant and first data transmission, at block 512 the UE compares the transport block size and radio resource information of the first grant with the transport block size and radio resource information of the second grant. As previously discussed, the transport block size is based on the transport block index and allocated time slots included in the grant in addition to the UE category.

If the transport block size has changed, the UE determines the second data is a new data transmission. Thus, at block 514, the UE flushes the buffer storing the first data and attempts to decode the second data. In the present configuration, the UE transmits an ACK to the NodeB if the second data is successfully decoded (not shown). Alternatively, the UE transmits a NACK to the NodeB if the second data is not successfully decoded (not shown).

Furthermore, if the transport block size is the same, the UE determines that the second data is a re-transmission and at block 516, the UE stores the second data in a temporary buffer, such as a temporary HARQ buffer. Moreover, at block 518, the UE attempts to decode the second data stored in the temporary buffer without a soft combine. If the decoding is successful, then at block 520, the UE flushes both the temporary buffer and the buffer and transmits an ACK to the NodeB. If the decoding is unsuccessful, then at block 522, the UE performs a soft combine of the second data in the temporary buffer and the first data in the buffer. Furthermore, at block 524, the UE attempts to decode the combined data. If the decoding is successful, the UE flushes the buffer, at block 526. If the decoding is not successful, then at block 528, the UE moves second data from the temporary buffer to overwrite the buffer.

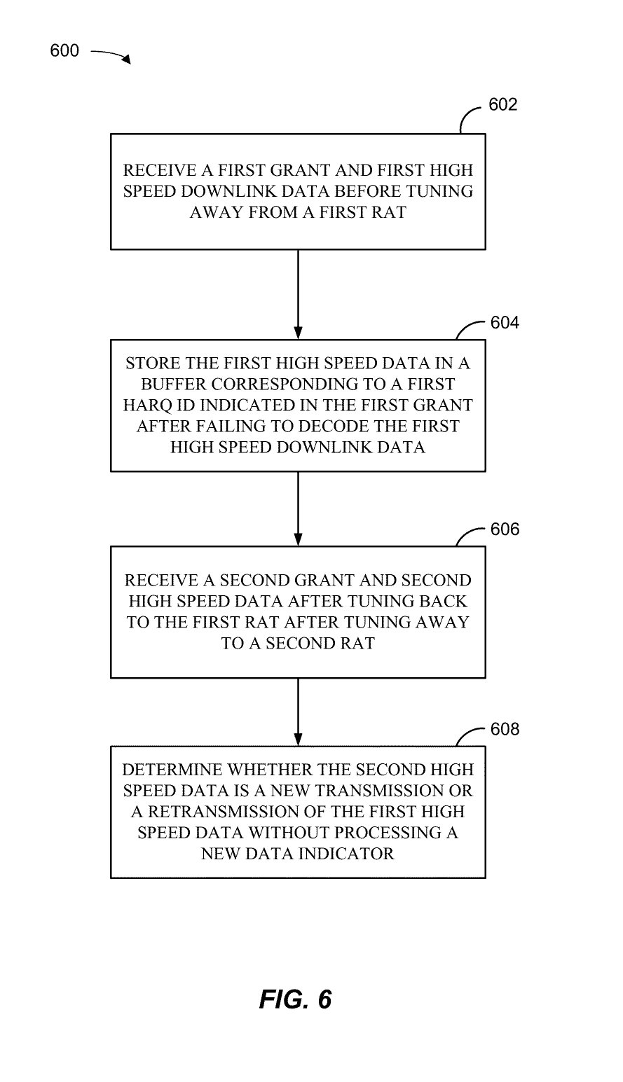

FIG. 6 shows a wireless communication method 600 according to one aspect of the disclosure. A UE receives a first grant and first high speed downlink data before tuning away from a first RAT, as shown in block 602. The UE also stores the first high speed data in a buffer corresponding to a first HARQ ID indicated in the first grant after failing to decode the first high speed downlink data, as shown in block 604. Additionally, as shown in block 606, the UE receives a second grant and second high speed data after tuning back to the first RAT after tuning away to a second RAT. Finally, as shown in block 606, the UE determines whether the second high speed data is a new transmission or a retransmission of the first high speed data without processing a new data indicator.

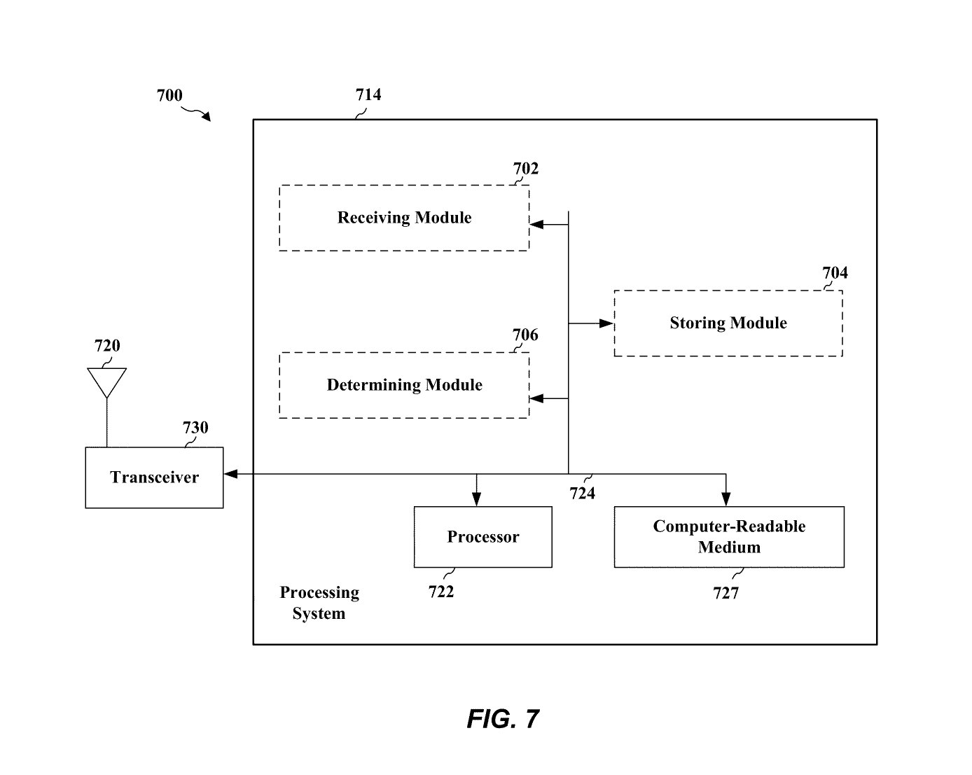

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706 and the non-transitory computer-readable medium 727. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 727. The processor 722 is responsible for general processing, including the execution of software stored on the computer-readable medium 727. The software, when executed by the processor 722, causes the processing system 714 to perform the various functions described for any particular apparatus. The computer-readable medium 727 may also be used for storing data that is manipulated by the processor 722 when executing software.

The processing system 714 includes a receiving module 702 for receiving a first grant and first high speed downlink data before tuning away from a first RAT. The receiving module 702 may also be configured to receive a second grant and second high speed data after tuning back to the first RAT after tuning away to a second RAT. The processing system 714 includes a storing module 704 for storing. the first high speed data in a buffer corresponding to a first HARQ ID indicated in the first grant after failing to decode the first high speed downlink data. The processing system 714 includes a determining module 706 for determining whether the second high speed data is a new transmission or a retransmission of the first high speed data without processing a new data indicator. The modules may be software modules running in the processor 722, resident/stored in the computer readable medium 727, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for receiving. According to an aspect of the present disclosure, the receiving means may be the antennas 352, the receiver 354, the channel processor 394, the receive frame processor 360, the receive processor 370, the controller/processor 390, the memory 392, grant determining module 391, receiving module 702, and/or the processing system 614 configured to perform the receiving. The UE is also configured to include means for storing. In one configuration, the storing means may be the controller/processor 390, the memory 392, grant determining module 391, storing module 704 and/or the processing system 714 configured to perform the storing. The UE may also be configured to include means for determining. According to an aspect of the present disclosure, the receiving means may be the channel processor 394, the receive frame processor 360, the receive processor 370, the controller/processor 390, the memory 392, grant determining module 391, determining module 706, and/or the processing system 614 configured to perform the receiving. In one configuration, the means functions correspond to the aforementioned structures. In another configuration, the aforementioned means may be a module or any apparatus configured to perform the functions recited by the aforementioned means.

Several aspects of a telecommunications system has been presented with reference to TD-SCDMA, TD-HSDPA, and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a first grant and first high speed downlink data before tuning away from a first radio access technology (RAT);
storing the first high speed data in a buffer corresponding to a first hybrid automatic repeat request (HARQ) identification (ID) indicated in the first grant after failing to decode the first high speed downlink data;
receiving a second grant and second high speed data after tuning back to the first RAT after tuning away to a second RAT; and
determining whether the second high speed data is a new transmission or a retransmission of the first high speed data without processing a new data indicator (NDI).

2. The method of claim 1, in which the determining comprises determining whether a second HARQ ID received in the second grant is the same as a the first HARQ ID.

3. The method of claim 2, in which the determining comprises determining whether a second transport block size associated with the second grant is a same size as a first transport block size associated with the first grant.

4. The method of claim 3, further comprising:
storing the second high speed data in a temporary buffer when the second transport block size is not the same size as the first transport block size; and
attempting to decode the second high speed data stored in the temporary buffer.

5. The method of claim 4, further comprising flushing the temporary buffer and the buffer when decoding is successful.

6. The method of claim 4, further comprising
combining the first high speed data stored in the buffer and the second high speed data stored in the temporary buffer when the second high speed data is not successfully decoded; and
attempting to decode the combined high speed data.

7. The method of claim 6, further comprising flushing both the temporary buffer and the buffer when the combined high speed data is successfully decoded.

8. The method of claim 6, further comprising overwriting the buffer with the second high speed data stored in the temporary buffer and releasing the temporary buffer when the combined high speed data is not successfully decoded.

9. The method of claim 1, in which the first grant includes a transport block index, and in which a transport block size is determined based at least in part on the transport block index and a radio resource allocated in the first grant.

10. An apparatus for wireless communication, the apparatus comprising:
a memory unit; and
at least one processor coupled to the memory unit; the at least one processor being configured:
to receive a first grant and first high speed downlink data before tuning away from a first radio access technology (RAT);
to store the first high speed data in a buffer corresponding to a first hybrid automatic repeat request (HARQ) identification (ID) indicated in the first grant after failing to decode the first high speed downlink data;
to receive a second grant and second high speed data after tuning back to the first RAT after tuning away to a second RAT; and
to determine whether the second high speed data is a new transmission or a retransmission of the first high speed data without processing a new data indicator (NDI).

11. The apparatus of claim 10, in which the at least one processor is further configured to determine whether a second HARQ ID received in the second grant is the same as a the first HARQ ID.

12. The apparatus of claim 11, in which the at least one processor is further configured to determine whether a second transport block size associated with the second grant is a same size as a first transport block size associated with the first grant.

13. The apparatus of claim 12, in which the at least one processor is further configured:
to store the second high speed data in a temporary buffer when the second transport block size is not the same size as the first transport block size; and
to attempt to decode the second high speed data stored in the temporary buffer.

14. The apparatus of claim 13, in which the at least one processor is further configured to flush the temporary buffer and the buffer when decoding is successful.

15. The apparatus of claim 13, in which the at least one processor is further configured:
to combine the first high speed data stored in the buffer and the second high speed data stored in the temporary buffer when the second high speed data is not successfully decoded; and
to attempt to decode the combined high speed data.

16. The apparatus of claim 15, in which the at least one processor is further configured to flush both the temporary buffer and the buffer when the combined high speed data is successfully decoded.

17. The apparatus of claim 15, in which the at least one processor is further configured to overwrite the buffer with the second high speed data stored in the temporary buffer and releasing the temporary buffer when the combined high speed data is not successfully decoded.

18. The apparatus of claim 10, in which the first grant includes a transport block index, and in which a transport block size is determined based at least in part on the transport block index and a radio resource allocated in the first grant.

19. An apparatus for wireless communication, the apparatus comprising:
means for receiving a first grant and first high speed downlink data before tuning away from a first radio access technology (RAT);
means for storing the first high speed data in a buffer corresponding to a first hybrid automatic repeat request (HARQ) identification (ID) indicated in the first grant after failing to decode the first high speed downlink data;
means for receiving a second grant and second high speed data after tuning back to the first RAT after tuning away to a second RAT; and
means for determining whether the second high speed data is a new transmission or a retransmission of the first high speed data without processing a new data indicator (NDI).

20. A computer program product for wireless communication in a wireless network, comprising:
a non-transitory computer-readable medium having non-transitory program code recorded thereon, the program code comprising:
program code to receive a first grant and first high speed downlink data before tuning away from a first radio access technology (RAT);
program code to store the first high speed data in a buffer corresponding to a first hybrid automatic repeat request (HARQ) identification (ID) indicated in the first grant after failing to decode the first high speed downlink data;
program code to receive a second grant and second high speed data after tuning back to the first RAT after tuning away to a second RAT; and
program code to determine whether the second high speed data is a new transmission or a retransmission of the first high speed data without processing a new data indicator (NDI).
